(19) United States
(12) Patent Application Publication
(10) Pub. No.: US 2010/0122665 A1
(43) Pub. Date: May 20, 2010

(54) Treat-embedded Cat Scratching Apparatus

(76) Inventor: Robert Joseph Delzio, San Diego, CA (US)

Correspondence Address: Robert J. Delzio, 10345 Crosscreek Terrace, San Diego, CA, 92131, US

(21) Appl. No.: 12/272,035

(22) Filed: Nov. 17, 2008

(51) Int. Cl. A01K 15/02

(52) U.S. Cl. 119/706

(57) ABSTRACT

A treat-embedded cat scratching apparatus is disclosed. The treat consists of morsels of dry food which a cat likes to eat. The cat scratching apparatus comprises a scratching surface. Embedded within the scratching surface are morsels of dry food which a cat likes to eat.

### BACKGROUND OF THE INVENTION

Cat scratching apparatuses have been in existence for many years. Ideally, a cat scratching apparatus is used exclusively by a domestic cat to sharpen its claws, thereby preserving valuable furniture, carpeting, and garments which would otherwise be the likely target of a cat. However, convincing a cat to sharpen it claws on the cat scratching apparatus has always been a most difficult task.

The treat-embedded cat scratching apparatus, the invention disclosed herein, is designed to provide a cat with the necessary incentive to use a cat scratching apparatus. The embedded treat consists of dry food morsels which a cat likes to eat. A cat will naturally be attracted to the embedded dry food morsels. Scratching action by a cat on the treat-embedded cat scratching apparatus will release the dry food morsels for consumption. A strong incentive for a cat to use the treat-embedded cat scratching apparatus is evident.

Examples of cat scratching apparatuses are shown in U.S. Pat. Nos. 3,486,485 and 7,117,821. However, to date, no cat scratching apparatus exists as the herein disclosed treat-embedded cat scratching apparatus.

This invention, the treat-embedded cat scratching apparatus, serves a unique function in providing a strong incentive for use by a cat. Furthermore, the invention is an improvement over other existing cat scratching apparatuses.

### OBJECT AND SUMMARY OF THE INVENTION

An object of this invention is to provide a cat scratching apparatus with an effective incentive for actual use by a cat. That incentive is the embedded dry food treats within the surface of the cat scratching apparatus.

This invention provides a much higher probability of actual use by a cat of the treat-embedded cat scratching apparatus as compared to prior art units which offer solely a scratching surface for a cat.

### BRIEF DESCRIPTION OF THE DRAWINGS

FIG. 1 is the isometric view of a corrugated scratching surface.

FIG. 2 is the exploded view of a corrugated scratching surface depicting embedded treats or dry cat food morsels.

### DETAILED DESCRIPTION OF THE PREFERRED EMBODIMENT

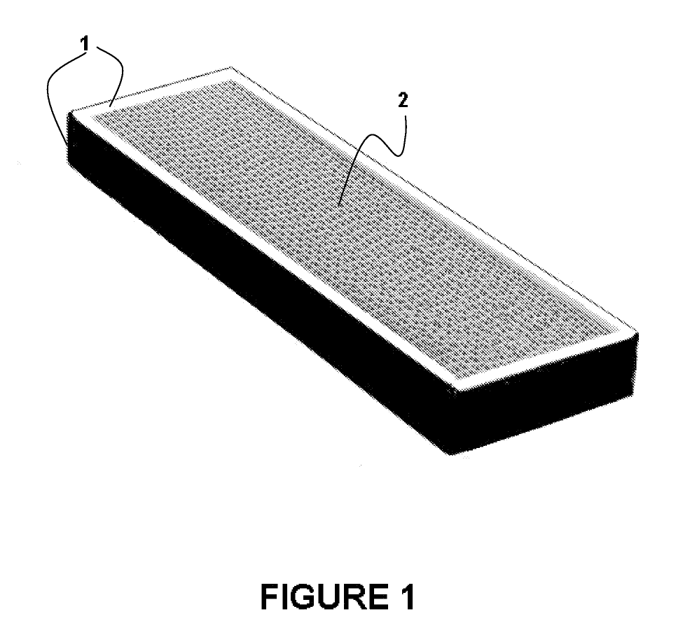

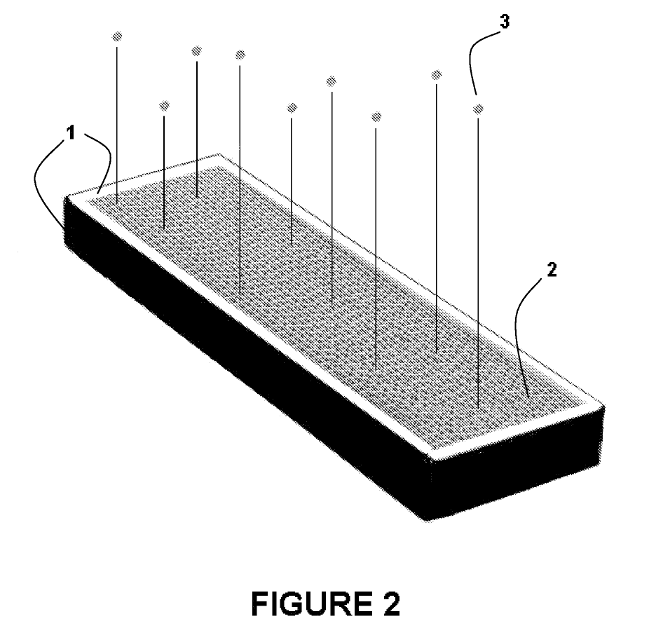

Referring in more detail to the drawings, there is shown in FIG. 1 and FIG. 2, a cat scratching apparatus which comprises a casing 1 and a scratching surface of corrugated material 2 stacked on edge.

Embedded within the scratching surface are treats or dry food morsels 3 that a cat likes to eat. This presents a strong incentive to a cat to use the cat scratching apparatus.

Scratching action of a cat upon the scratching surface releases the treats or dry food morsels for consumption by the cat.

While preferred embodiments of the present invention have been shown and described, herein, it is obvious that many structural details may be changed without departing from the spirit and scope of the claims. Any changes, envisioned or actual, are limited only by the claims.

I claim:

1. A scratching apparatus comprising a scratching material, that a cat likes to scratch, which is embedded with an edible substance that a cat likes to eat.

2. A scratching apparatus comprising a scratching material, that a cat likes to scratch, which is embedded with a fragrance of an edible substance that a cat likes to eat.
